(19) United States
(12) Patent Application Publication
(10) Pub. No.: US 2016/0197732 A1
(43) Pub. Date: Jul. 7, 2016

(54) PORTABLE POWER OVER ETHERNET SUPPLY DEVICE

(71) Applicant: DEREK LOCK BURNETT, ST. LOUIS, MO (US)

(72) Inventor: DEREK LOCK BURNETT, ST. LOUIS, MO (US)

(21) Appl. No.: 14/591,853

(22) Filed: Jan. 7, 2015

(51) Int. Cl. H04L 12/10; H02J 7/00

(52) U.S. Cl. CPC H04L 12/10; H02J 7/007

(57) ABSTRACT

Embodiments of the present invention provide a device, system, and method for providing portable battery power to a Power of Ethernet-enabled device. The portable PoE supply device includes a battery component configured for supplying PoE via an Ethernet interface to a PoE-enabled device. The portable PoE supply device also provides for in-place configuration and analysis of PoE-enabled device. The portable PoE supply device may further support wireless communication with other wireless-enabled devices. The portable PoE supply device also includes mounting attachments that support utilizing the PPPD in a safe and secure manner. The portable PoE supply device adds flexibility to installation schedules in that an existing PoE infrastructure does not need to be in place to install and configure PoE-enabled devices.

### BACKGROUND

The installation, configuration, and servicing of power of Ethernet (PoE) devices is generally limited when a network infrastructure has not yet been installed. At times, a network connection to the network infrastructure may also have to be disconnected for troubleshooting existing PoE-enabled devices. Without a network infrastructure or a connection to power, PoE-enabled devices have to be installed, configured, or serviced in-place with an alternate source of power.

In-place installation, configuration, and servicing may further need analysis of a PoE-enabled device to confirm proper functioning of the PoE-enabled device. In-place installation, configuration, and servicing may also occur in precarious places that raise safety issues for a technician supporting the PoE-enabled device. For example, a PoE surveillance camera may be serviced using ladders or lifts that need a technician to maintain proper balance. A technician may also need free hands to perform supporting tasks. Conventional methods and systems for supporting PoE-enabled devices fail to account for a portable PoE supply device for supporting PoE-enabled devices. In particular, these methods and systems do not accommodate in-place analysis and configuration tools that provide safe working conditions for supporting PoE-enabled devices.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein generally relate to a portable power over Ethernet (PoE) supply device for supporting PoE-enabled devices. The portable PoE supply device includes an enclosure, at least one Ethernet interface, a wireless communications interface, and a battery component located within the enclosure, the battery component is configured to supply PoE via the Ethernet interface to a PoE-enabled device. The battery component supplies PoE power via the Ethernet interface while the Ethernet interface simultaneously communicates a data stream of the PoE-enabled device to the wireless communications interface. As such, the device facilitates in-place analysis and configuration tools that provide safe working conditions for supporting PoE-enabled devices.

### BRIEF DESCRIPTION OF THE SEVERAL VIEWS OF THE DRAWING

Illustrative embodiments of the present invention are described in detail below with reference to the attached drawing figures, which are incorporated herein by reference, wherein:

FIGS. 1A-B depict exemplary portable PoE supply devices in operating environments, in accordance with embodiments of the present invention;

FIG. 2 depicts a flow diagram including steps of a method that is carried out in accordance with an embodiment described herein;

FIG. 3 depicts a flow diagram including steps of a method that is carried out in accordance with an embodiment described herein;

FIG. 4 depicts an exemplary portable PoE supply device in an operating environment, in accordance with embodiments of the present invention;

FIG. 5 depicts a top view of an exemplary portable PoE supply device in accordance with an embodiment of the present invention;

FIG. 6 depicts a bottom view of an exemplary portable PoE supply device in accordance with an embodiment of the present invention;

FIG. 7 depicts a front view of an exemplary portable PoE supply device in accordance with an embodiment of the present invention;

FIG. 8 depicts a back view of an exemplary portable PoE supply device in accordance with an embodiment of the present invention;

FIG. 9 depicts a left view of an exemplary portable PoE supply device in accordance with an embodiment of the present invention;

FIG. 10 depicts a right view of an exemplary portable PoE supply device in accordance with an embodiment of the present invention;

FIG. 11 depicts an isometric view of an exemplary portable PoE supply device in accordance with an embodiment of the present invention; and

FIG. 12 is a block diagram of an exemplary computing environment suitable for use in implementing embodiments described herein.

### DETAILED DESCRIPTION OF THE INVENTION

Power over Ethernet delivers data and electrical power to Power-over-Ethernet-enabled devices such as wireless access points or Internet cameras, from a single Cat5 Ethernet cable. Power may be carried on the same conductors as the data, or it may be carried on dedicated conductors in the same cable. Using the convenience of PoE eliminates the need to place a device near a power outlet, giving more freedom in placement and easy cable management.

PoE may be supported via a PoE network infrastructure that supplies data to an Ethernet power hub. Data and power is provided by the Ethernet power hub to various devices such as VoIP (Voice over Internet Protocol) phone, network camera, Bluetooth access point, and wireless LAN access point. PoE may especially be applicable in circumstances where delivering power from a separate main power supply would be impractical or prohibitively expensive.

Problems arise when PoE-enabled devices have to be installed, configured, or serviced. The installation, configuration, and servicing of PoE-enabled devices are particularly limited when a network infrastructure has not yet been installed. This impacts flexibility in scheduling installations for PoE-enabled. At times, a network connection to the network infrastructure may also have to be disconnected for troubleshooting existing PoE-enabled devices to determine if the network infrastructure is the issue.

Without a network infrastructure or when troubleshooting PoE-enabled devices, PoE-enabled devices have to be installed, configured, or serviced in-place with an alternate source of power. In-place installation, configuration, and servicing may further need analysis of a PoE-enabled device to confirm proper functioning of the PoE-enabled device. In-place installation, configuration, and servicing may also occur in precarious places that raise safety issues for a technician supporting the PoE-enabled device. For example, a PoE surveillance camera may be serviced using ladders or lifts that need a technician to maintain proper balance but also needing free hands to perform support tasks. Additional inefficiencies may also include the need for a second technician for safe PoE service tool operation and or a nearby AC outlet. Conventional methods and devices for supporting PoE-enabled devices fail to account for a portable PoE supply device for supporting PoE-enabled devices. Moreover, these methods and devices do not accommodate for in-place analysis and configuration tools that also provide safe working conditions for support PoE-enabled devices.

Embodiments of the present invention provide a simple and efficient device, system, and method for providing portable PoE to a PoE-enabled device. The portable PoE supply device includes a battery component configured for supplying PoE via an Ethernet interface to the PoE-enabled device. The portable PoE supply device provides for in-place configuration and analysis of the PoE-enabled device. The portable PoE supply device may further support wireless communication with other devices. As such, the portable PoE supply device also supports remote configuration and analysis of the PoE-enabled device.

The portable PoE supply device also includes mounting attachments that support utilizing the portable PoE supply device in a safe and secure manner. The portable PoE supply device may have mounting attachments and/or mounting assembly to securely attach the portable PoE supply device to a surface. In embodiments, the portable PoE supply device is attachable via a clip or karabiner providing a technician a safe way for transporting and operating the portable PoE supply device while servicing a PoE-enabled device, for example, on a ladder. Different types of mounting attachments are contemplated with embodiments of the present invention. For example, a mounting attachment can be a clamp that is fixedly or removeably attached the portable PoE supply device. The mounting attachment can be configured to be attached on different types of surfaces such that a technician using the portable PoE supply device can utilize the portable PoE supply device in a hands-free manner.

The battery power supply feature of the portable PoE supply device adds flexibility to installation schedules in that an existing PoE infrastructure does not need to be in place to install and configure PoE-enabled devices. The mounting attachment feature supports increased safety when working with PoE-enabled devices in precarious locations. Embodiments of the present invention can also include a power indicator feature to external communicate different aspects of the power of the portable PoE supply device. The power indicator may merely indicate that the portable PoE supply device is turned on or off, indicate that the PoE-enabled device is actively receiving power from the battery, or indicate that the battery component is being charged. As such, a power indicator can provide different types of indications of power functionality associated with the portable PoE supply device. Other variations and combination of power indicator features are contemplated with embodiments of the present invention.

The portable PoE supply device further includes a wireless communications component that allows the user to connect the portable PoE supply device to wifi-enabled devices, e.g., via a web browser or other types of interfaces. In embodiments, the portable PoE supply device may connect wirelessly to a portable PoE supply device retrofitted with a tablet device for installing, configuring, and servicing a PoE-enabled device connected to the portable PoE supply device.

It is contemplated that the portable PoE supply device can include a built-in adjustable voltage converter mechanism. The adjustable voltage converter mechanism supports adjustable voltage of battery power from the portable PoE supply device. In this regard, the portable PoE supply device can provide a specific voltage output of power to a PoE-enabled device associated with the portable PoE supply device.

Accordingly, a first embodiment of the present invention is provided. A portable power over Ethernet device includes an enclosure. The portable PoE supply device further includes at least one Ethernet interface, a wireless communications interface, and a battery component located within the enclosure. The battery component is configured to supply PoE via the Ethernet interface to a PoE-enabled device.

A second embodiment of the present invention is provided. A portable PoE supply device includes an enclosure. The portable PoE supply device further includes at least one Ethernet interface and a wireless communications interface, where the wireless communications interface is configured to support mobile broadband functionality. The portable PoE supply device also includes a battery component located within the enclosure, the battery component is configured to supply PoE via the Ethernet interface to a PoE-enabled device, where the battery component supplies PoE via the Ethernet interface while the Ethernet interface simultaneously communicates a data stream of the PoE-enabled device through the wireless communications interface. The data stream can specifically include configuration data for installing, configuring, and servicing the PoE-enabled device. The data stream being communicated from the portable PoE supply device simultaneously with the battery power to the PoE-enabled device. The portable PoE supply device also includes an adjustable voltage converter connected to the battery component, where the adjustable voltage converter is adjustable to provide a specific output voltage from the battery component to the PoE-enabled device.

A third embodiment of the present invention is provided. A retrofitted portable PoE supply device includes an enclosure. The portable PoE supply device further includes at least one Ethernet interface and a battery component located within the enclosure, the battery component configured to supply PoE via the Ethernet interface to a PoE-enabled device. The portable PoE supply device includes a tablet device having a computing device operably coupled to a display a wireless communications interface within the tablet device and a wireless communications interface within the enclosure.

Additional objects, advantages, and novel features of the invention are set forth in the description which follows and will become apparent to those ordinarily skilled in the art upon examination of the following, or may be learned by practice of the invention.

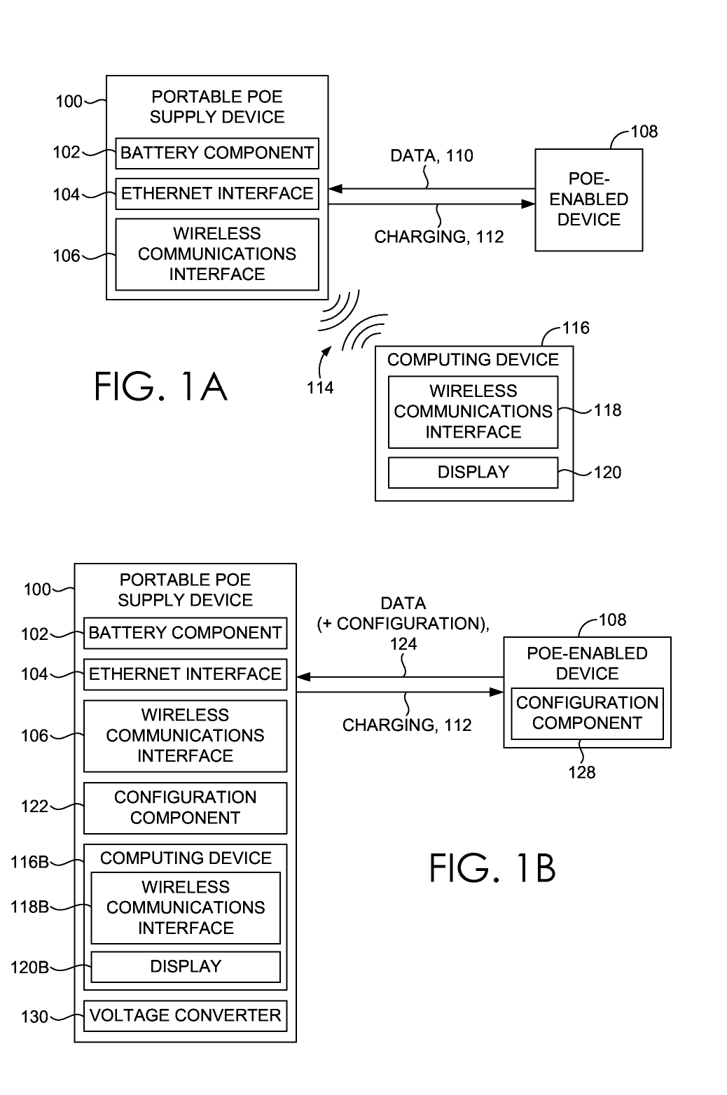

Embodiments of the present invention can be described with reference to FIGS. 1A and 1B. Referring initially to FIG. 1A, FIG. 1A shows a portable PoE supply device 100 in an operating environment according to embodiments of the present invention. The portable PoE supply device includes, among other components not depicted, a battery component 102, an Ethernet interface component 104, a wireless communications component 106. The operating environment in FIG. 1A further includes a PoE-enabled device 108 and a computing device 116 having a wireless communications interface 118 and a display 120.

It should be understood that this and other arrangements described herein are set forth only as examples. Various functions described herein as being performed by one or more entities may be carried out by hardware, firmware, and/or software. For instance, various functions may be carried out by a processor executing instructions stored in memory. Other arrangements and components (e.g., components, interfaces, functions, orders, and groupings of functions, etc.) can be used in addition to or instead of those shown, and some components may be omitted altogether. Further, many of the components described herein are functional entities that may be implemented as discrete or distributed components or in conjunction with other components, and in any suitable combination and location.

The portable PoE supply device 100 may refer to a portable battery power source device configured to provide portable PoE to PoE-enabled devices. In embodiments, the portable PoE supply device 100 includes an enclosure, an on/off switch, a battery charging interface, a USB (Universal Service Bus) interface and a built-in or retrofitted computing device (e.g., a table device) as discussed in more detail below.

The portable PoE supply device 100 also includes at least one battery component 102, an Ethernet interface 104 and a wireless communications interface 106. The portable PoE supply device 100 may be used to install, configure, and service a PoE-enabled device (e.g., PoE-enabled device 108) where the network infrastructure and/or an alternate power source are not readily available. The portable PoE supply device 100 may or may not be actively connected to an external power source.

With continued reference to FIG. 1A, the battery component 102 can be configured to supply PoE via the Ethernet Interface 104 to a PoE-enabled device 108. The battery component 102 may be removeably attached to the portable PoE supply device 100. The battery component 102 may also be fixedly attached to the portable PoE supply device. The battery component 102 may be disposable or rechargeable. As such, in an embodiment where the battery component is fixedly attached to the portable PoE supply device 100 and rechargeable, the portable PoE supply device 100 may include a battery charging interface (not shown) for receiving power to charge the battery component 102. The battery charging interface may be configured as a second Ethernet interface or AC/DC input for receiving power to charge the battery component 102. Other types of battery charging interfaces are contemplated within the scope of embodiments of the present invention.

The battery component 102 may be configured to store battery power and supply the battery power to the PoE-enabled device 108 via an Ethernet interface 104. The Ethernet interface 104 can pass electrical power along with data on Ethernet cabling. Power may be carried on the same conductors as the data, or it may be carried on dedicated conductors in the same cable.

The Ethernet interface 104 comprises an Ethernet connection which supplies power from the battery component 102. The Ethernet interface 104 is configured to be compatible with existing PoE-enabled devices. The Ethernet interface 104 may be connected to the PoE-enabled device 108 by an Ethernet cable. The Ethernet cable may be any standard four-twisted-pair cable suitable for use in an Ethernet device, such as a category 5 (Cat 5) cable or a category 6 (cat 6) cable. The Ethernet interface 104 may be configured to activate or deactivate the charging of the PoE-enabled device 108 based on the presence or absence of a connection with the PoE-enabled device 108. Supplying or disconnecting power to the PoE-enabled device 108 can also be based on an on/off switch. The Ethernet interface can be used for simultaneously communicating data 110 and charging 112 the PoE-enabled device. Charging and supplying power to the PoE-enabled are used herein interchangeably to indicate power from the portable PoE supply device is being transmitted to the PoE-enabled device.

With reference to FIG. 1B, the portable PoE supply device can include a configuration component 122, computing device 116B having a wireless communications interface 118B, display 120B, and the PoE-enabled device 108 having a configuration component 128. In the embodiment depicted in FIG. 1B, the Ethernet interface 104 can be configured for simultaneously communicating data comprising configuration information 124 from the configuration component 128 of the PoE-enabled device 108 and charging 112 the PoE-enabled device 108. The data comprising the configuration information can be communicated to the configuration component 122. The computing device 116B having the display 120B can retrieve display the configuration information for assisting with installing, configuring, and service the PoE-enabled device. The computing device 116B can be wired or wirelessly communicate with the configuration component 122 to retrieve configuration information. Configuration information from PoE-enabled can generally refers to any information that indicate features of the PoE-enabled device and/or support the functionality of the PoE-enabled device 108. The configuration information can be analyzed using the computing device 116B.

The computing device 116B can include the display 120B that generally comprises an output interface for presentation in a visual or tactile form. By way of example, the display 120B may be a touchscreen electronic visual display that a user can control through simple or multi-touch gestures by touching the screen. The touchscreen may enable the user to interact directly with what is displayed. The display 120B may communicate internal and external functionality information associated with the portable PoE supply device 110. Information can range from information on monitoring charge levels of the battery component 104 to information for configuring the PoE-enabled device 108. Any variation and combination of information for communication via the display 120B are further contemplated within the scope of embodiments of the present invention.

The computing device 116B can also facilitate installing, configuring, and servicing the PoE-enabled device 108 via the configuration component 122. For example, upon review of configuration information from the PoE-enabled device 108, a technician can input configuration information via the computing device 116B. The computing device 116B can communicate the information to the PoE-enabled device and via the configuration component 122 and the Ethernet interface 104. At the PoE-enabled device, the configuration component 128 can receive the configuration information from the computing device 124 to configure and support functionality of the PoE-enabled device 108.

It is further contemplated that the computing device 116B can communicate with internal components and external components using a wired connection. For example, the computing device 116B may include a physically coupled connection that provides direct connection with an internal component or external component. The physical connection may be used instead of a wireless connection in situations where a wired connection may be more appropriate than a wireless connection. For example, the computing device may communication with battery component 102, the Ethernet component 104, the wireless communications 106, and the configuration component 122 for gathering information and providing functionality described herein.

With continued reference to FIG. 1A, the wireless communication interface 106 is configured for communicating 114 data wirelessly to internal and external components of the power PoE supply device 100. For example, the computing device 116 may be configured to communicate data (e.g., installation, configuration, or servicing data) through the wireless communications interface 106. The wireless communications interface 106 allows the portable PoE supply device 100 to exchange data or connect to the internet wireless using radio wave. The portable PoE supply device 100 using the wireless communications interface 106 may connect to one or more wireless enabled devices for communicating data. The portable PoE supply device 100 may communicate with a centralized hub (not shown) that supports a servicing application or connect to a computing device (e.g., tablet) that supports portable access to the information received from the PoE-enabled device 108 and/or the portable PoE supply device 100. It is contemplated that the computing device may have an independent (e.g., computing device 116) or built-in or retrofitted (e.g., computing device 116B) associated with the portable PoE supply device 100.

The data communicated via the wireless communications interface 106 can specifically be data used for installing, configuring or servicing the PoE-enabled device as discussed above. In this regard, the functionality described herein of the computing device 116 and the computing device 116B can be imputed to each other as allowed by their structural component. Specifically, the computing device 116 may be configured to support installation, configuration, and service of the PoE-enabled device 116. For example, the computing device 116 may receive diagnostic data from the PoE-enabled device 108 that helps in troubleshooting issues with the PoE-enabled device 108. The computing device 116 may also monitor features and functions of the portable PoE supply device 100. For example, the computing device 116 may monitor the charge level of the battery in response to direct current to or away from the battery component 102. The computing device 116 may also include one or more applications (not shown). An application may specifically be included in a memory of the computing device to support the configuration of the PoE-enable device 108. Additional applications may support different types of features that are related or unrelated to the portable PoE supply device 100.

Turning to FIG. 1B, the portable PoE supply device can include a voltage converter and in embodiments an adjustable voltage mechanism 130. The portable PoE supply device 100 device may be configured to deliver varying watts of power to different types of PoE-enabled devices. The voltage converter converts electric power which changes the voltage of an electrical power source. In this regard, the voltage converter can be combined to the battery component to support the functionality of the portable PoE supply device. It is contemplated that the portable PoE supply device can include an adjustable voltage mechanism such that the transmitted electrical power is set to a specific output from the battery component. The specific out can be associated with an expected electrical power transmission of the PoE-enabled device. In embodiments, the electrical power from the battery component that charges the PoE-enabled device can be communicated simultaneously with data to and from the PoE-enabled device.

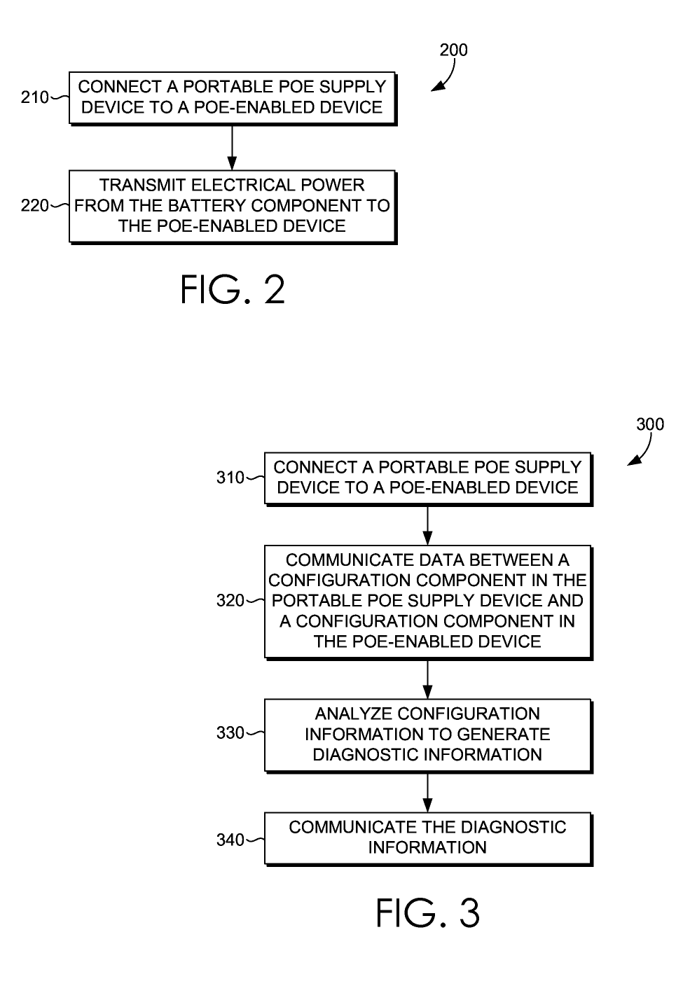

Turning to FIG. 2, a flow diagram 200 of an illustrative process for supplying portable PoE based on a portable PoE supply device is provided. The method includes, at block 210, connecting a portable PoE supply device to a PoE-enabled device using an Ethernet interface of the portable PoE supply device. The method includes, at block 220, transmitting using a battery component, electrical power from the battery component to the PoE-enabled device. It is contemplated that the portable PoE supply device can include an adjustable voltage mechanism such that the transmitted electrical power is set to a specific output from the battery component. The specific out can be associated with an expected electrical power of the PoE-enabled device. In embodiments, the electrical power from the battery component that charges the PoE-enabled device can be communicated simultaneously with data to and from the PoE-enabled device.

Turning to FIG. 3, a flow diagram 300 of an illustrative process for diagnosing a PoE-enabled device based on a portable PoE supply device is provided. The method includes at block 310, connecting a portable PoE supply device to a PoE-enabled device using an Ethernet interface of the portable PoE supply device. The method further includes, at block 320, communicating data between a configuration component in the portable PoE supply device and a configuration component of the PoE-enabled device, the data includes configuration information. It is contemplated that the configuration data can be communicated simultaneously with transmitting using a battery component, electrical power from the battery component to the PoE-enabled device. At block 330, the configuration component in the portable PoE supply device can analyze the configuration information and generate diagnostic information.

At block 340, the diagnostic information and/or the configuration information can be communicated to one or more components. Diagnostic information can communicated to an internal computing device having a display. The internal computing device may be built-in or retrofitted to the portable PoE supply device. The diagnostic information can also be communicated to an external computing device. Communicating the diagnostic information can be facilitated by a wireless communications interface. It is contemplated that the diagnostic information can include resolution information that can be communicated via the Ethernet interface to the PoE-enabled device to install, configure, or service the PoE-enabled to support functionality thereof.

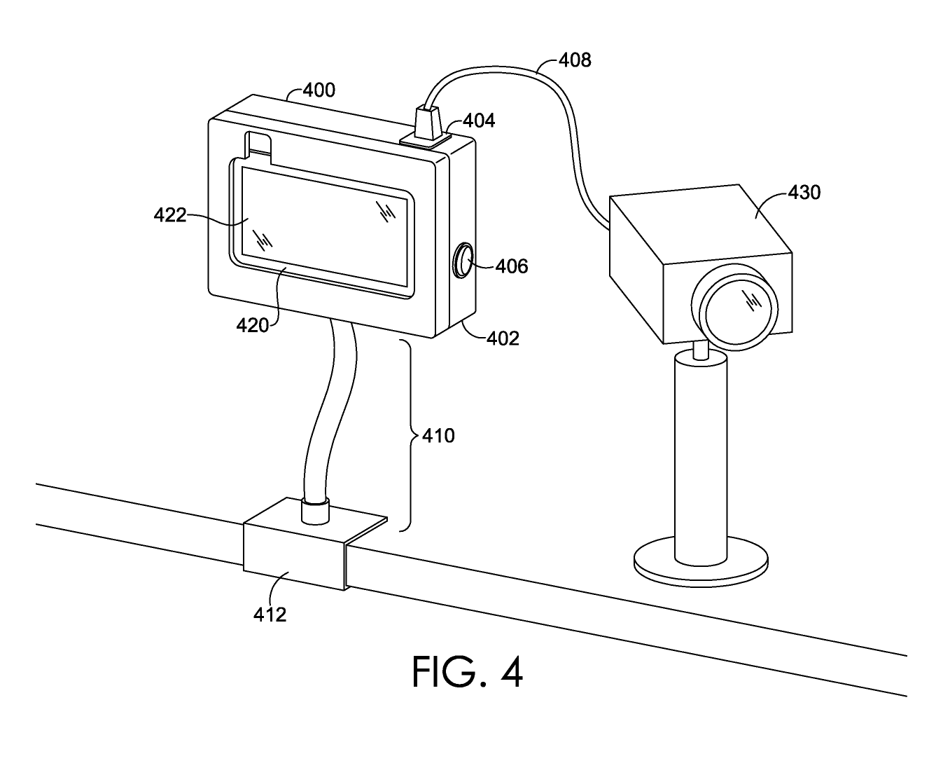

With reference to FIG. 4, FIG. 4 shows an exemplary portable PoE device mounted using mounting attachments 412 of a mounting assembly 410. The portable PoE supply device includes mounting attachments 412 that support utilizing the portable PoE supply device in a safe and secure manner. The portable PoE supply device may have mounting attachments 412 attached to the mounting assembly 410 to securely attach the portable PoE supply device to a surface. Other types of mounting attachments and mounting assemblies are contemplated with embodiments of the present invention.

With continued reference to FIG. 4, a portable PoE supply device retrofitted with a tablet device 420 is provided. The portable PoE supply device 400 further includes at least Ethernet interface 404, a battery component (not shown), and a wireless communications interface (not shown) located within the enclosure 402. The portable PoE supply device includes an on/off switch 406 that triggers transmitting electrical power from the battery component to the PoE-enabled device 430. The PoE-enabled device 430 can be a camera that receives electrical via the Ethernet interface 404 using an Ethernet cable 408.

The tablet device 420 can be a computing device that provides the functionality of computing devices described with embodiments of the present invention. For example, the table device 420 operably coupled to a display 422. Further, the tablet device 420 is configured to monitor the battery component to provide a plurality of monitored information via the display 422. The tablet device 420 may also support the configuration the PoE-enabled device 430. The POE-enabled device 430 may be configured using an application running via the tablet device 420. Data used in configuring the PoE-enabled device 430 may be received via the Ethernet interface 404 from the PoE-enabled device. It is contemplated that data may be transferred to wired and wireless communications interfaces of the portable PoE supply device 400. In particular, the enclosure or tablet device may include the wireless communications interface and may further include a secondary communications interface in the tablet device. The secondary communications interface comprising a wired or wireless interface configured to communicate with a component internal or external to the enclosure.

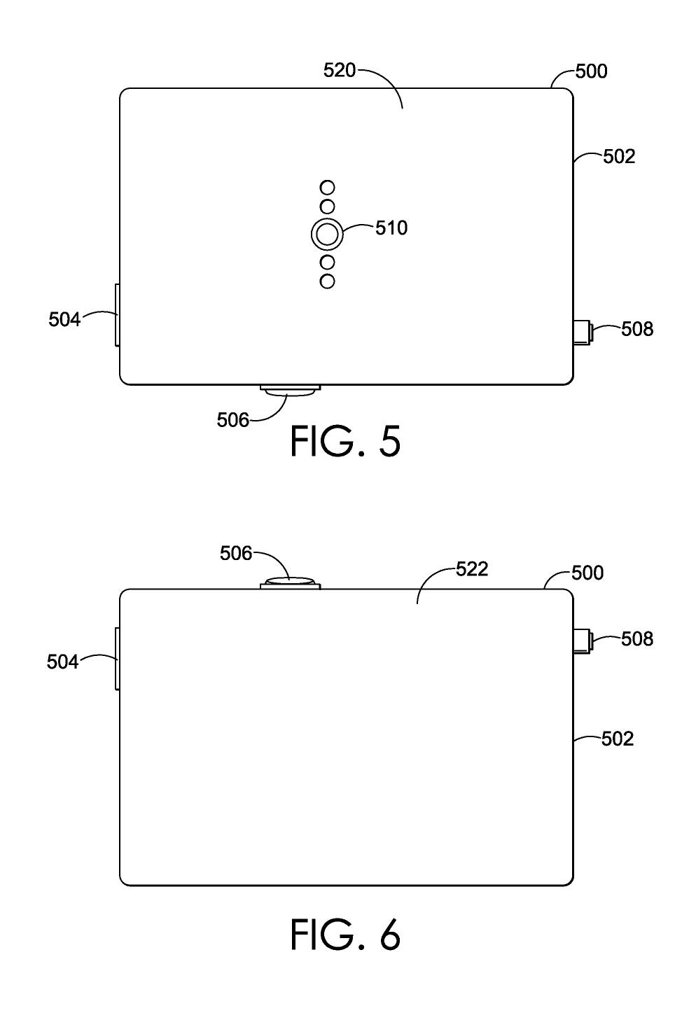

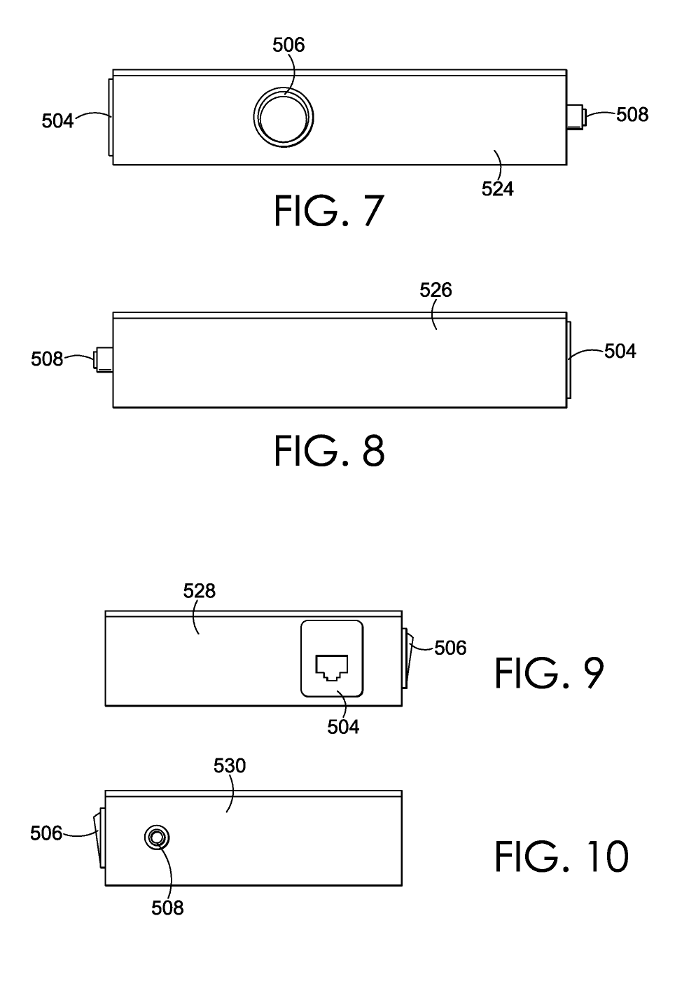

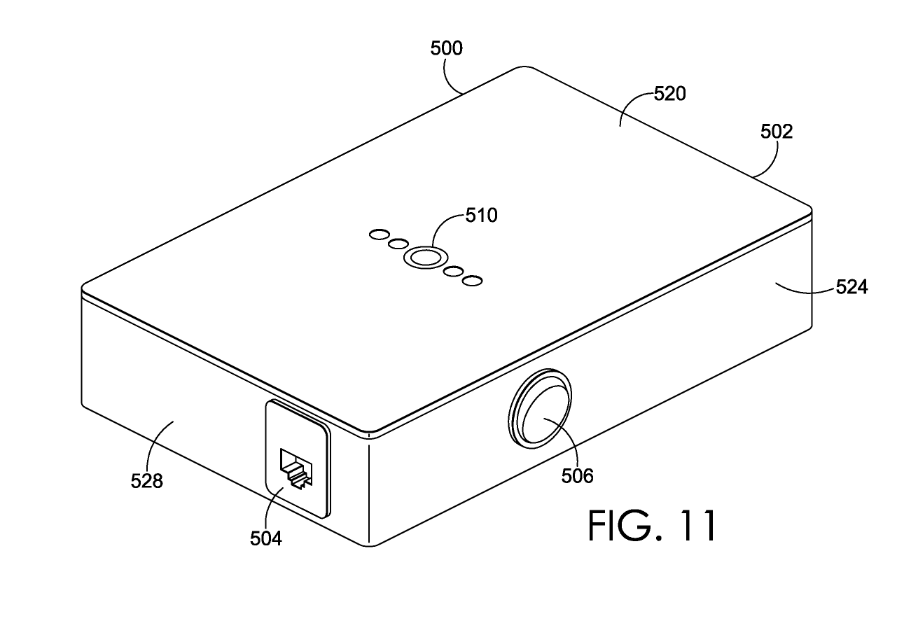

With reference to FIGS. 5-11 depict an exemplary embodiment of the present invention in several views. The portable PoE supply device 500 can be described with reference to the plurality of views. The portable PoE supply device 500 comprises an enclosure 502, an Ethernet interface 504, an on/off switch 506, a battery charging interface 508, and a power indicator 510 in accordance with embodiments described herein. The portable PoE supply device further includes a top 520 having the power indicator 510, a bottom 522, a front 524 having the on/off switch 506, a back 526, a left 528 having the Ethernet interface 504 and a right 530 having the battery charging interface 508.

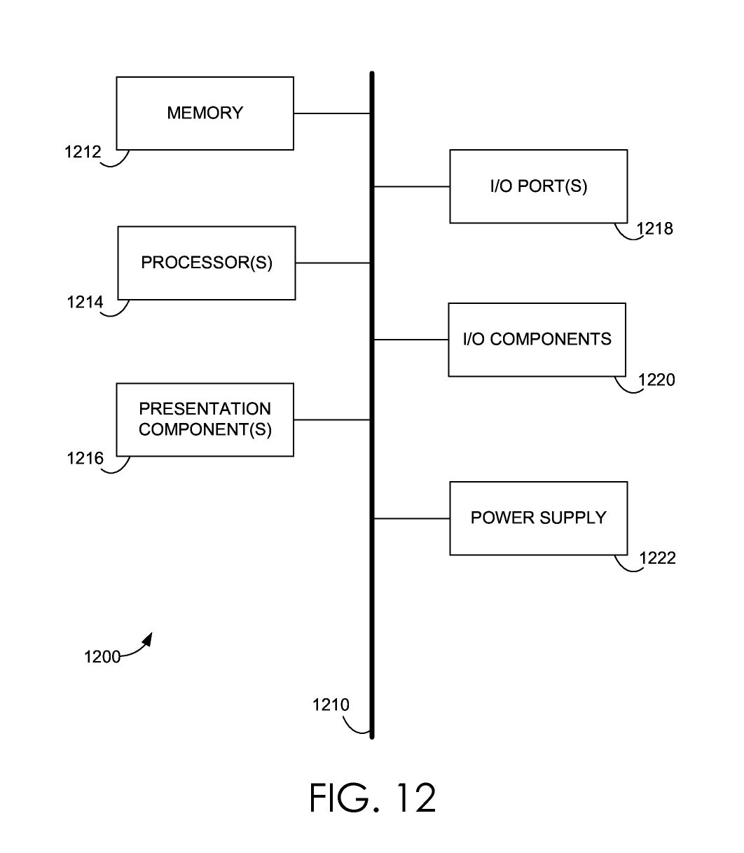

Having briefly described an overview of embodiments of the present invention, an exemplary operating environment in which embodiments of the present invention may be implemented is described below in order to provide a general context for various aspects of the present invention. Referring initially to FIG. 12 in particular, an exemplary operating environment for implementing embodiments of the present invention is shown and designated generally as computing device 1200. Computing device 1200 is but one example of a suitable computing environment and is not intended to suggest any limitation as to the scope of use or functionality of the invention. Neither should the computing device 1200 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 12, computing device 1200 includes a bus 1210 that directly or indirectly couples the following devices: memory 1212, one or more processors 1214, one or more presentation components 1216, input/output ports 1218, input/output components 1220, and an illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 12 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1212 includes computer storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which may be built in. Illustrative components include a microphone, joystick, game pad, satellite dish, scanner, printer, wireless device, etc.

Embodiments of the presented herein have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

1. A portable power over Ethernet (PoE) supply device the device comprising:
an enclosure;
at least one Ethernet interface;
a wireless communications interface; and
a battery component located within the enclosure, the battery component configured to supply PoE via the Ethernet interface to a PoE-enabled device

2. The device of claim 1, wherein the portable PoE supply device supplies passive power over Ethernet.

3. The device of claim 1, wherein the battery component supplies PoE via the Ethernet interface while the Ethernet interface simultaneously communicates a data stream of the PoE-enabled device to the wireless communications interface.

4. The device of claim 1, wherein the battery component is connected to an adjustable voltage converter, wherein the adjustable voltage converter is adjustable to provide a specific output voltage from the battery component to the PoE-enabled device.

5. The device of claim 4, wherein the specific output voltage comprises at least two different voltage settings from the battery component.

6. The device of claim 1, wherein the wireless communications interface is further configured to support mobile broadband functionality.

7. The device of claim 1, wherein the battery component is disposable or rechargeable.

8. The device of claim 1, wherein the battery component is removeably coupled to the portable PoE supply device

9. The device of claim 1, further comprising a battery charging interface, wherein the battery charging interface is configured to recharge the battery component.

10. A portable PoE supply device the device comprising:
an enclosure;
at least one Ethernet interface;
a wireless communications interface, wherein the wireless communications interface is configured to support mobile broadband functionality;
a battery component located within the enclosure, the battery component configured to supply PoE via the Ethernet interface to a PoE-enabled device, wherein the battery component supplies PoE power via the Ethernet interface while the Ethernet interface simultaneously communicates a data stream of the PoE-enabled device to the wireless communications interface; and
an adjustable voltage converter connected to the battery component, wherein the adjustable voltage converter is automatically adjustable to provide a specific output voltage from the battery component to the PoE-enabled device.

11. The device of claim 10, wherein a computing component is operably coupled to a display and the wireless communications interface, the display is configured to provide configuration information of components of the portable PoE supply device and a PoE-enabled device.

12. The device of claim 10, wherein the wireless communications interface is configured to transfer data to one or more wireless-enabled devices.

13. The device of claim 10, wherein data from the data stream comprises at least configuration information of the PoE-enabled device.

14. The device of claim 10, further comprising a mounting assembly for securely anchoring the portable PoE supply device on a surface.

15. The device of claim 10, wherein a computing component is operably coupled to a high resolution display interface providing at least 720p resolution and at least at least 16:9 aspect ratio.

16. A retrofitted portable PoE supply device the device comprising:
an enclosure;
at least one Ethernet interface;
a battery component located within the enclosure, the battery component configured to supply PoE via the Ethernet interface to a PoE-enabled device; and
a tablet device having a computing component operably coupled to a display and a wireless communications interface, the tablet device retrofitted as a portion of the portable PoE supply device.

17. The device of claim 16, wherein the tablet device is removeably attached to the enclosure.

18. The device of claim 16, further comprising a secondary communications interface in the enclosure, the secondary communications interface comprising a wired or wireless interface configured to communicate with a component internal or external to the enclosure.

19. The device of claim 16, wherein the battery charging interface is a PoE Ethernet port.

20. The device of claim 16, wherein the tablet device is operably connected to the battery component, the tablet component configured for:
supporting the configuration the PoE-enabled device, wherein configuring the POE-supported device is based on an application running via the tablet device, wherein at least a portion of data used in configuring the PoE-enabled device is received via the Ethernet interface; and
communicating data through the wireless communications interface, wherein the data comprises at least configuration information of the PoE-enabled device.
